(19) United States
(12) Patent Application Publication
(10) Pub. No.: US 2018/0333881 A1
(43) Pub. Date: Nov. 22, 2018

(54) SAW SHEATH

(71) Applicant: Barnel International, Inc., Portland, OR (US)

(72) Inventors: Linn E. Nelson, Portland, OR (US); Karl H. Zeller, Portland, OR (US)

(73) Assignee: Barnel International, Inc., Portland, OR (US)

(21) Appl. No.: 15/977,453

(22) Filed: May 11, 2018

Related U.S. Application Data
(60) Provisional application No. 62/506,939, filed on May 16, 2017.
(60) Provisional application No. 62/529,958, filed on Jul. 7, 2017.

(51) Int. Cl. B26B 29/00

(52) U.S. Cl. CPC B26B 29/00

(57) ABSTRACT

An improved saw sheath and saw provides smooth insertion and removal of the saw into and out of the sheath. Upper and lower bumper members help guide the saw into the sheath and assist in securing the saw in the sheath when stored. The guide members can be fixed slide members, flexing slide members, or fused roller members, for example.

### CROSS-REFERENCE TO RELATED APPLICATIONS

This application claims benefit of U.S. provisional patent application Ser. No. 62/506,939 filed May 16, 2017, and U.S. provisional patent application Ser. No. 62/529,958 filed Jul. 7, 2017.

### BACKGROUND

This disclosure relates to horticultural/landscape tools and more particularly to a hand saw and sheath thereof.

Hand saws for use in the field typically include a wearable sheath that allows the user to safely wear the saw via a belt clip, keeping the saw conveniently located for ease of access. The sheath should securely retain the saw when not in use, but allow smooth and easy removal of the saw from the sheath and smooth and easy replacement of the saw back into the sheath when cutting operations are finished. Alternative saw sheath mounting attaches the sheath to the leg for use by arborist tree climbers, using hook and loop straps to secure the sheath to the leg.

### SUMMARY

In accordance with the disclosure, a saw and sheath includes bumper members for securing the saw within the sheath while allowing easy removal. The bumpers can be one or more members that allow the saw handle to slide along, providing some compression of an elastomeric portion of the handle or spring action of the bumper to move out of the way as the saw enters the sheath, and moving back to help secure the saw in the sheath once fully inserted.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a perspective view of a saw with sheath, with the saw partially inserted into the sheath;

FIG. 2 is a partial perspective view of the saw and sheath with the saw fully inserted;

FIG. 3 is a partial perspective view of the saw and sheath with the saw removed;

FIG. 4 is a cross sectional view of the saw and sheath taken along line 4-4 of FIG. 1, with the saw partially inserted;

FIG. 5 is a cross sectional view of the saw and sheath taken along line 4-4 of FIG. 1, with the saw fully inserted.

FIG. 6 is a cross sectional view of the saw and sheath taken along line 4-4 of FIG. 1, illustrating an alternative top bumper configuration;

FIG. 7 is a cross sectional view of the saw and sheath taken along line 4-4 of FIG. 1, illustrating an a further alternative bumper configuration; and

FIG. 8 is a perspective view of a saw employing fused roller members.

### DETAILED DESCRIPTION

According to a preferred embodiment of the present disclosure, an improved saw sheath is provided to allow easy insertion and removal of the saw from the sheath, while properly holding the saw in place when inserted into the sheath.

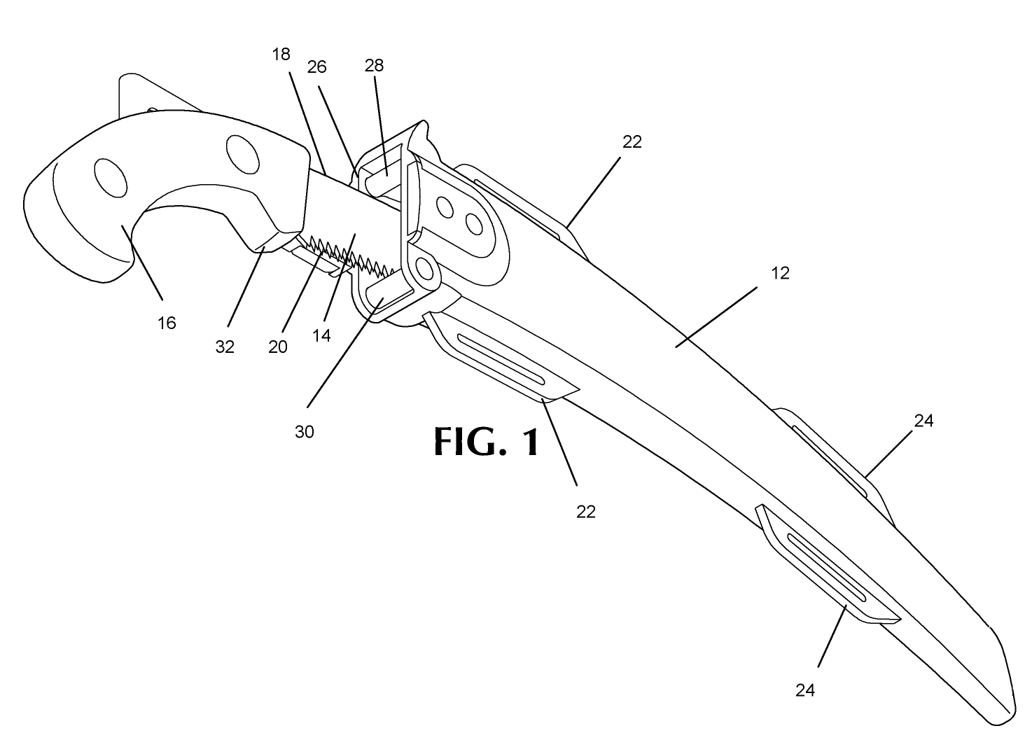

FIG. 1 is a perspective view of a saw with sheath 10, with the saw partially inserted into the sheath. The sheath 12 is elongate and in the illustrated embodiment, curved slightly to correspond to the curved profile of the particular saw blade 14. Handle 16 is secured to the back end of the saw so that a user can grasp the handle to use the saw. The handle is suitably a cushioned rubber grip, for example made of a TPR (Thermoplastic Rubber), ensuring a slip resistant handle that enables a secure grip even when wet. The upper side 18 of the saw blade is generally smooth, while the lower side of the blade has plural saw teeth 20. In a preferred embodiment, the saw has a hollow ground blade with impulse laser hardened SK4 steel and a hard chrome finish. A portion of the blade extends into the handle material for secure mounting of the blade to the handle, promoting strength. The blade can be provided with different lengths to adapt for different requirements in the field, typical lengths being between 240-330 mm (9.4-13 inches).

The sheath can be provided with upper and lower strap mounts 22, 24, to allow a strap to engage the sheath for securing the sheath to a user's leg to minimize undesired movement of the sheath during use in the field.

The sheath defines an insertion opening 26 for receiving the saw blade therein, and upper and lower bumper members 26, 28 are positioned at the upper and lower sides of the opening.

The saw handle 16 has an ergonomic profile to comfortably fit a user's hand, carrying a forward bumper 32 at the lower side thereof.

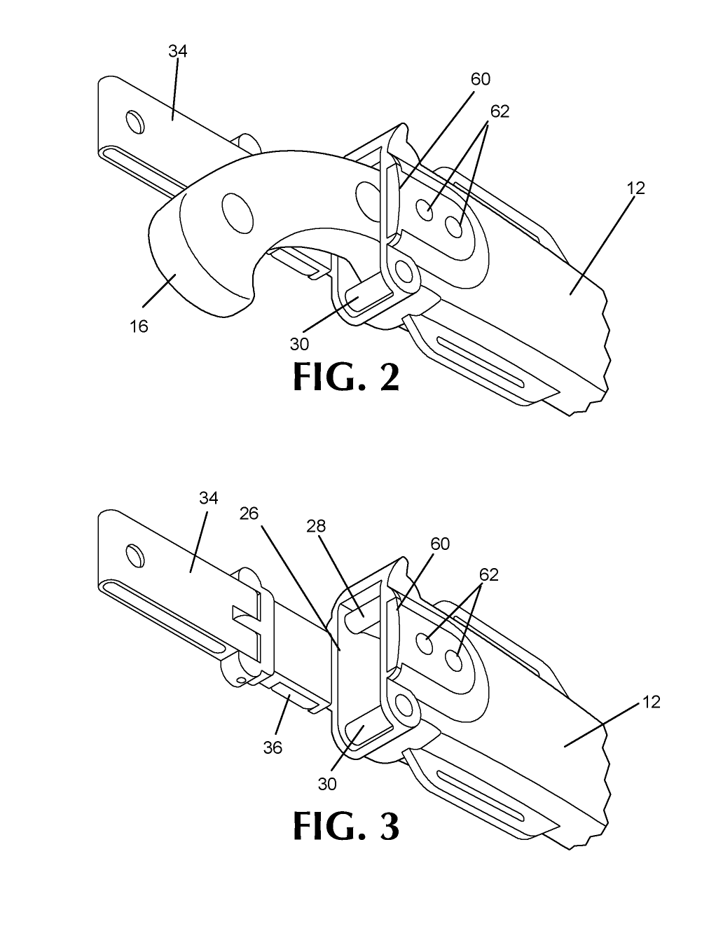

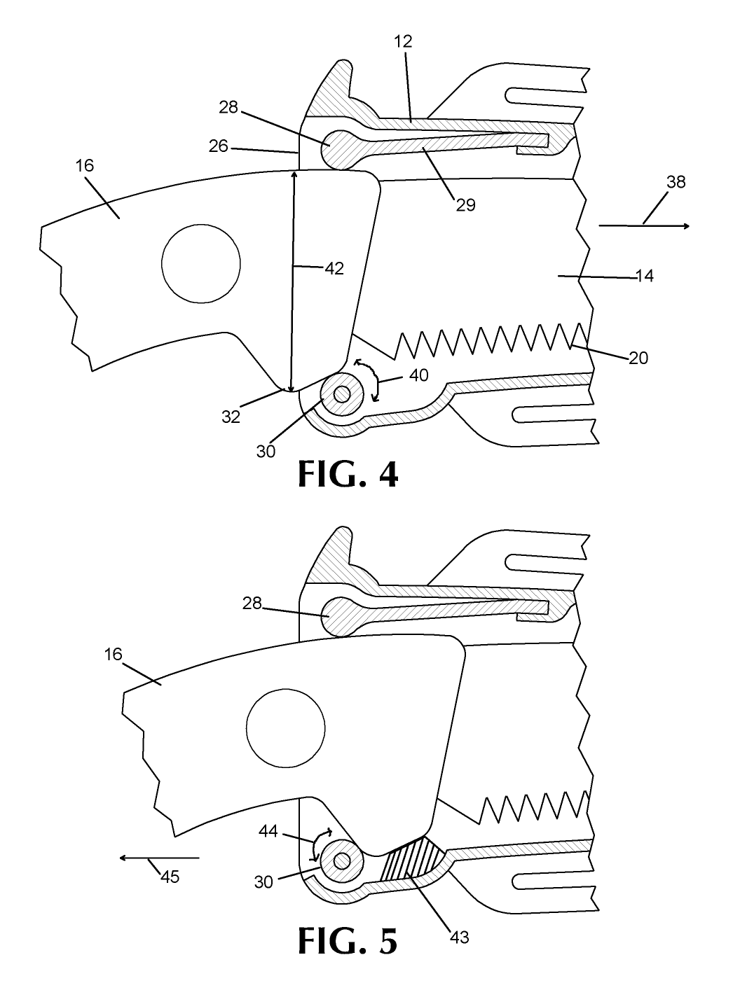

Referring now to FIG. 2, a partial perspective view of the saw and sheath with the saw fully inserted into the sheath, in the configuration of FIG. 2, when the saw is fully inserted, bottom bumper member 30 cooperates with forward bumper 32 of the saw handle to removably secure the saw in the sheath, as will be discussed further in connection with FIGS. 4 and 5.

FIG. 3 is a partial perspective view of the saw and sheath with the saw removed. The sheath includes a belt clip 34 mounted thereon, so that the sheath can be secured to the user's belt. The belt clip can include a quick release fastener 36 to allow quick removal of the sheath without requiring that the belt clip be removed. Also, in the illustration, the belt clip is mounted to the left side of the sheath. The sheath includes left and right belt clip mounting receiving members 60, the right side member visible in FIGS. 2 and 3. The left side member has a corresponding shape and features. Fastener holes 62 are provided, and the member carrying quick release fastener 36 fits into the receiving member 60, with 2 spring loaded latch members that extend through fastener holes 62, to allow the belt clip to be removably attached to either the left or right side of the sheath, allowing either right or left handed use of the saw.

Referring now to FIGS. 4 and 5, cross sectional views of the saw and sheath taken along line 4-4 of FIG. 1, with the saw partially inserted (FIG. 4) and with the saw fully inserted (FIG. 5), the saw is inserted into the sheath by introducing the tip of the saw into the mouth 26 of the sheath and moving the saw into the sheath in the direction of arrow 38. As the handle portion of the saw begins to enter the mouth of the sheath, the upper portion of the handle will begin to slide against bumper 28, while the lower portion of the handle, bumper 32, will begin to interact with the sheath's bumper 30. Bumper 28 is mounted to the sheath via a flexible member 29, allowing flexing of the bumper upwardly and downwardly as shown by arrow 31, as the bumper interacts with the handle. In the configuration of FIGS. 4 and 5, sheath bumper 30 is a roller adapted to rotate in the direction shown by arrow 40 as the saw is inserted to the sheath. The upper and lower bumpers 28, 30 provide an opening that is slightly narrower than the maximum with 42 of the handle, and given the elastomeric nature of the handle material and the flexibility of member 29, the handle and/or opening will slightly deform to allow the bumper 32 to move past the roller. Once the bumper 32 moves past the roller, as in FIG. 5, the forward lower face of the handle engages with a stop member 43 (shown in FIG. 5 only) that defines the forwardmost position that the saw will move into the sheath. The saw is thus secured in place in the sheath by engagement between the stop member 43 and handle bumper 30. Thus, the saw is stored in the sheath until the user removes the saw, by pulling on the handle in the direction of arrow 45, whereby the bumper roller 30 will rotate in the direction of arrow 44 as it interacts with handle bumper 32. The flexing of arm 29 of bumper 28 also can contribute to both securing and removal of the saw by the spring movement provided by the arm.

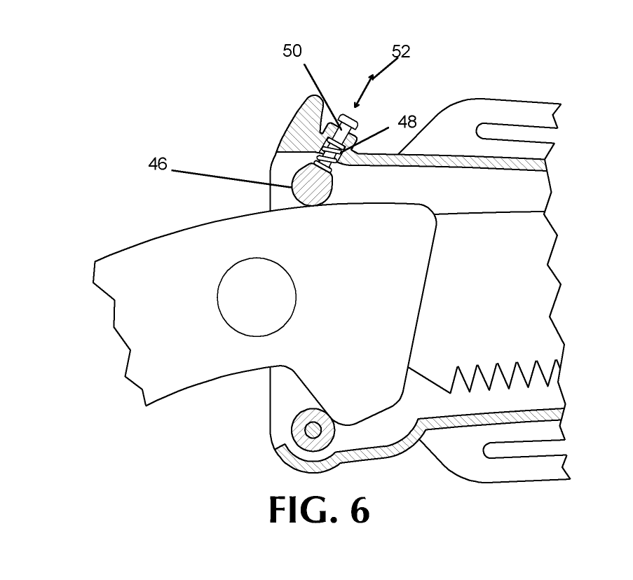

FIG. 6 illustrates an alternative embodiment of the sheath, the view being a cross sectional view of the alternative sheath taken along line 4-4 of FIG. 1. In this configuration, top bumper 28 is replaced with a spring loaded bumper member 46 which is biased toward the direction of the saw handle by spring member 48. Slidable mounting post 50 carries the bumper 46 and interacts with the sheath to allow movement upwardly and downwardly along the directions of arrow 52, so that a downward bias is provided to the bumper 46, but the bumper is able to move upwardly away as the saw handle passes into and out of the sheath.

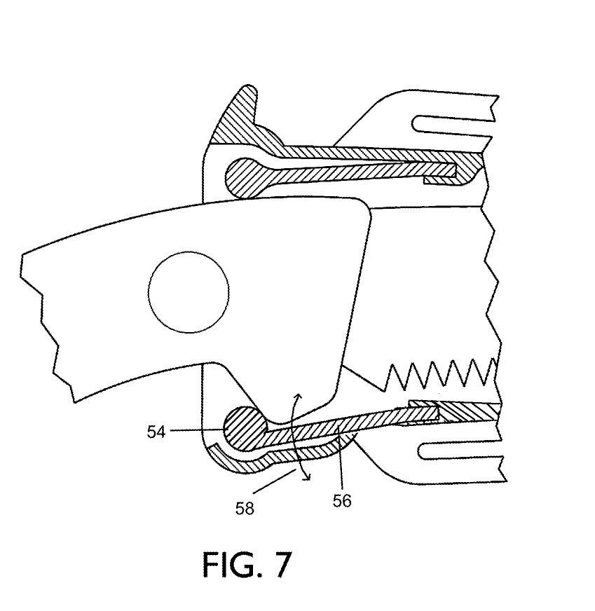

Still a further embodiment is illustrated in FIG. 7, a cross sectional view of a saw and sheath taken along line 4-4 of an alternative embodiment of FIG. 1, wherein bottom bumper 30 is replaced with a bumper 54 mounted via flexing arm 56 that flexes in the motions of arrow 58 and having a configuration and operation corresponding to the configuration of upper bumper 28 of FIG. 4. Thus this embodiment employs no roller function for its bumpers. Still further, an upper bumper corresponding to bumper 46 of FIG. 6 can be employed in an embodiment such as this.

The bumpers 28, 46 and 54 can suitably be made of a low friction and high wear resistance material, such as acetal homopolymer resin sold under the trademark Delrin or related, to provide a surface that enhances the sliding movement of the handle past the bumpers. Roller bumper 30 is suitable made of a plastic, but the bumpers 28, 30, 46 and 48 can also be made of metal. Roller bumper 30 can be of an elastomeric material to allow deformation as the handle passes by (in which case the handle can be of a less or non-elastomeric material. Roller bumper 30 can also be mounted to allow deformation movement of the rolling axis thereof, to move the roller slightly out of the way as the handle moves past.

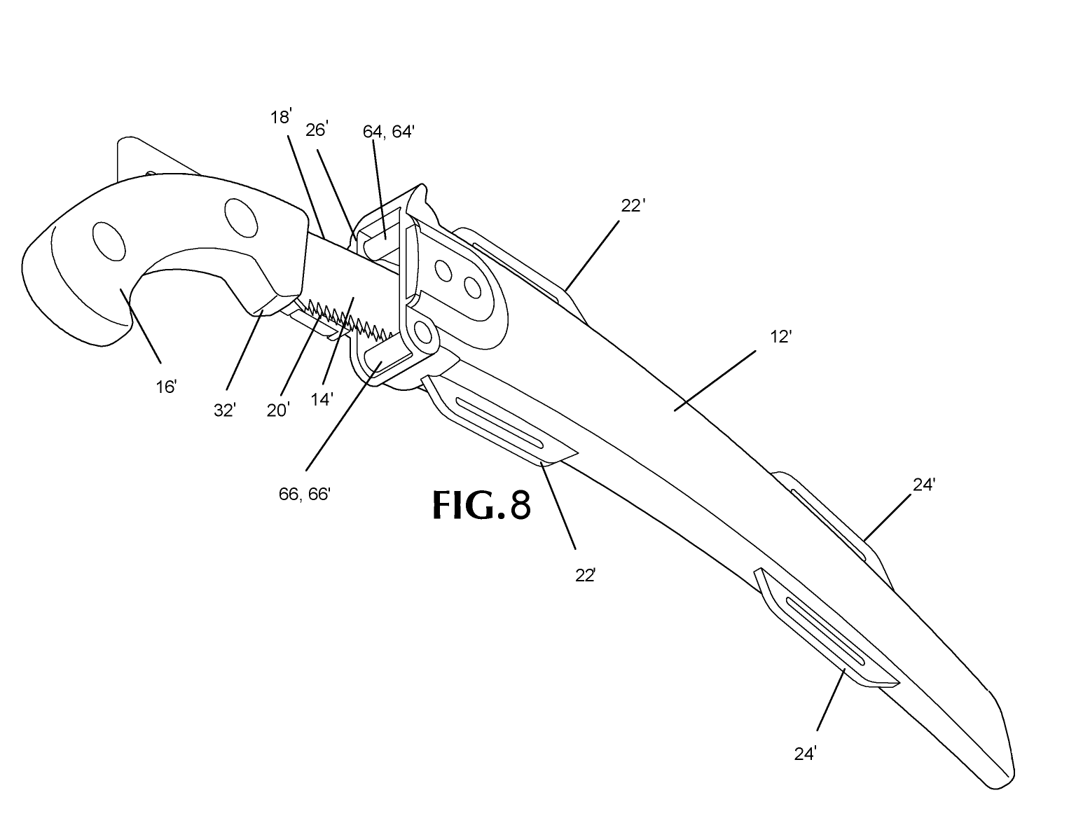

FIG. 8 is a perspective view of a saw employing fused roller members. In the prior art, sheaths are known that employ both upper and lower rollers 64, 66 in the mouth of the sheath. In accordance with the present disclosure, the upper or lower rollers can be fused so that they no longer function as rollers and instead function as a fixed surface 64′, 66′ that allows the saw to slide thereon when inserting or removing from the sheath. The fusing can be accomplished by applying an adhesive, or heat treatment to sufficiently melt the components such that the rollers no longer roll and therefore are no longer considered to be rollers. Depending on the particular roller configuration, a mechanical blocking component can be inserted that prevents the roller from rotating. Alternatively, the rollers 64, or 66 can be replaced with a fixed surface, made of a material such as the low friction and high wear resistance material (e.g. acetal homopolymer resin sold under the trademark Delrin or related material).

In accordance with the embodiments shown, a saw sheath and saw is provided that provides ease of use and durability.

While a plural embodiments of the technology have been shown and described, it will be apparent to those skilled in the art that many changes and modifications may be made without departing from the broader aspects. The appended claims are therefore intended to cover all such changes and modifications as fall within the true spirit and scope of the technology.

What is claimed is:

1. A sheath for a saw, the sheath having an opening for receiving the saw therein,
the opening defining an upper and lower side with respect to the axis of the thickness of the saw's blade,
the upper side and the lower side having a member for sliding engagement with the handle of the saw.

2. A sheath for a saw according to claim 1, wherein the member on the lower side comprises a roller.

3. A sheath for a saw according to claim 1, wherein the member on the upper side comprises a flexing member having sliding properties.

4. A sheath for a saw according to claim 1, wherein the member on the lower side comprises a roller and the member on the upper side comprises a flexing member having sliding properties.

5. A sheath for a saw according to claim 1, wherein the member on the lower side comprises a flexing member having sliding properties.

6. A sheath for a saw according to claim 1, wherein the member on the lower side comprises a flexing member having sliding properties and the member on the upper side comprises a flexing member having sliding properties.

7. A sheath for a saw according to claim 1, wherein the member on the upper side comprises a member having sliding properties, said member being biased to urge toward the handle of the saw.

8. A sheath for a saw according to claim 7, wherein the bias to urge toward the handle of the saw is provided by a spring.

9. A sheath for a saw according to claim 1, wherein the member on the upper side comprises a roller that has been altered to no longer function as a roller.

10. A sheath for a saw according to claim 9, wherein the roller is altered by fusing it to prevent rolling action.

11. A method for altering a saw sheath comprising one or more roller members at the opening of the sheath, comprising the steps of fusing at least one of the one or more roller members to prevent operation thereof as a roller.

12. A method for altering a saw sheath comprising one or more roller members at the opening of the sheath, comprising the steps of replacing at least one of the one or more roller members with a non-rolling member.
